(19) United States
(12) Patent Application Publication
(10) Pub. No.: US 2024/0146577 A1
(43) Pub. Date: May 2, 2024

(54) MULTIFUNCTIONAL NETWORK SWITCH FOR USE IN A PROCESS-CONTROLLING AUTOMATION SYSTEM, AND SUCH A PROCESS-CONTROLLING AUTOMATION SYSTEM

(71) Applicant: Phoenix Contact GmbH & Co. KG, Blomberg (DE)

(72) Inventor: Martin MUELLER, Lügde (DE)

(21) Appl. No.: 17/768,342

(22) PCT Filed: Oct. 13, 2020
(86) PCT No.: PCT/EP2020/078742

§ 371 Date: Apr. 12, 2022

(30) Foreign Application Priority Data
Oct. 14, 2019 (DE) 10 2019 127 551.2

(51) Int. Cl. H04L 12/66; H04L 49/65

(52) U.S. Cl. CPC H04L 12/66; H04L 49/65

(57) ABSTRACT

A multifunctional network switch for use in a process-controlling automation system, comprises a control unit, a plurality of ports, and a storage device that is adapted to store a first program for executing a network switch functionality and furthermore a second program for executing a control device functionality and/or a third program for executing a router functionality. The control unit is configured to execute a network switch functionality by running the first program and furthermore a control device functionality by running the second program and/or a router functionality by running the third program.

### FIELD

The invention relates to a multifunctional network switch for use in a process-controlling automation system, and also relates to such a process-controlling automation system.

### BACKGROUND

Industrial automation technology employs process-controlling automation systems which have a modular configuration, inter alia, and which, in addition to an external power supply device, usually can comprise a router, a network switch, a control device, for example in the form of a programmable logic controller (PLC) for controlling a production process, and a plurality of input and/or output modules. All components can have a modular design and can be mounted on a mounting rail spatially separated from one another. In conventional automation systems, communication between the control device and the input and/or output modules occurs via a first bus system, such as MIO bus, while communication between the control device, the network switch, and the router takes place via a second bus system, for example Ethernet. The external power supply device is usually connected via cable to the router, the network switch, and to the control device and optionally to the input and/or output modules.

### SUMMARY

The present invention is based on the object of providing a multifunctional network switch and a process-controlling automation system which enable less cabling complexity, less installation space requirements, and simplified communication.

What can be considered as a key idea of the invention is to provide a multifunctional network switch which, in addition to the actual network switch functionality, is capable of executing at least one additional functionality, namely a control device functionality and/or a router functionality, which can be stored and installed in the form of virtual machines in the multifunctional network switch. At this point it should be noted that a network switch functionality is preferably implemented in layer 2 of the OSI layer reference model, while a router functionality is implemented in layer 3 of the OSI layer reference model. For example, the control device functionality assumes all the tasks of a conventional programmable logic controller (PLC).

The aforementioned technical problem is solved by the features of claim 1 and by the features of claim 8.

Advantageous embodiments are specified in the dependent claims.

### BRIEF DESCRIPTION OF THE DRAWING

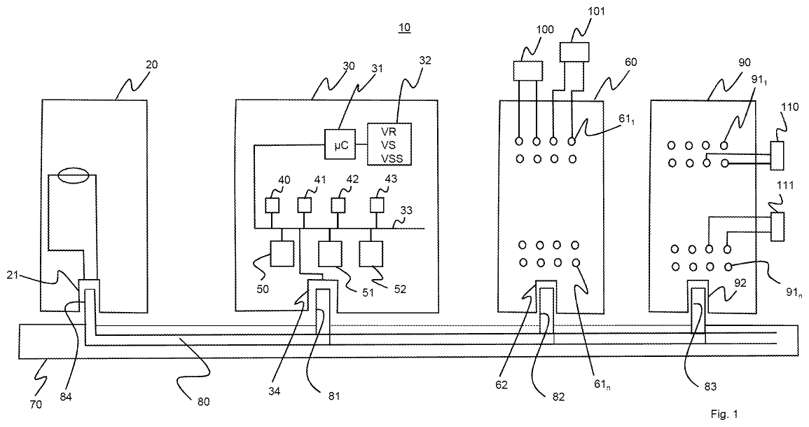

The invention will now be explained in more detail by way of an exemplary embodiment in conjunction with FIG. 1.

### DETAILED DESCRIPTION

FIG. 1 shows an exemplary process-controlling automation system 10 which may comprise, for example, an external power supply device 20, a multifunctional network switch 30 and at least one input and/or output module 60 for connecting field devices such as, for example, sensors and/or actuators. In addition to the input and/or output module 60, to which preferably safety-related field devices 100, 101 can be connected for controlling a safety-related process, the exemplary automation system 10 comprises an input and/or output module 90 to which preferably non-safety-related field devices 110 and 111 can be connected for controlling a non-safety-related process. The power supply device 20, the multifunctional network switch 30, and the input and/or output modules 60 and 90 can have a modular design and may in particular be adapted for being electrically connected to one another via a bus system 80. Bus system 80 may be arranged in a mounting rail 70 such as, for example, a top hat rail, wherein the power supply device 20, the multifunctional network switch 30, and the at least two input and/or output modules 60 and 90 can be adapted for being mounted on the top hat rail 70.

The multifunctional network switch 30 includes a control unit 31 which may preferably be provided as a microcontroller and in particular as a 500 MHz or even faster control unit. The control unit 31 is adapted, inter alia, to operate the multifunctional network switch 30 as a network switch, preferably as an Ethernet switch or a Gigabit Ethernet switch. Furthermore, the multifunctional network switch 30 has a plurality of ports 40-43 and 50-52 to which at least one network segment and/or another communication network such as the Internet can be connected, for example, depending on the application or implementation. For example, ports 40-43 and 50-52 are in the form of RJ-45 plug-in connectors. However, the ports may also have different physical designs. Ports 40-43 and 50-52 may be electrically interconnected via an internal backplane 33, which may be a high-speed bus, for example. The control unit 31 and a communication interface 34 of the multifunctional network switch 30, via which the multifunctional network switch 30 can be connected to the bus system 80, for example, are preferably also connected to the high-speed bus 33. Furthermore, a storage device 32 is implemented in the multifunctional network switch 30, which storage device stores a first program for executing a network switch functionality. The first program can preferably be a firmware that operates the multifunctional network switch 30 as a network switch.

It should be noted that the multifunctional network switch 30 may preferably be implemented as a high-speed network switch which can support multiple high-speed ports, for example ports 40-43, in particular when executing the network switch functionality. Here, the term “high-speed” means that
(i) the high-speed ports, e.g. ports 40 to 43, are each capable of transmitting and receiving data at a data transfer rate of at least 100 Mbit/s, preferably 1 Gbit/s, 2.5 Gbit/s, 5 Gbit/s, 10 Gbit/s, 25 Gbit/s, 50 Gbit/s, 100 Gbit/s and more, independently of one another; and that
(ii) the multifunctional network switch 30 is adapted to switch data between the high-speed ports, e.g. ports 40 to 43, at the respective data transfer rates, preferably in response to a routing table.

For this purpose, the multifunctional network switch 30 preferably comprises an appropriate high-speed transfer means such as the aforementioned high-speed bus 33 which connects the high-speed ports, and a control unit 31 that works sufficiently fast, e.g. the aforementioned 500 MHz control unit. Furthermore, a buffer with sufficient storage capacity for storing data frames may be implemented. The buffer may be part of storage device 32 or may be implemented as a separate memory in the multifunctional network switch 30.

Preferably, the multifunctional network switch 30 may be embodied as a Gigabit Ethernet switch, such as of the VSC7449-01 type, which is capable of supporting 52 Gigabit Ethernet ports. A corresponding number of high-speed ports can then be implemented in the multifunctional network switch 30. In this context it should also be pointed out that the network switch functionality, in particular a high-speed network switch functionality as explained above by way of example, cannot be implemented as a pure virtual network switch in a PC. Rather, in this case, a network switch must be used which includes the hardware and performance specified above by way of example. In other words: In particular the network switch functionality to be executed by the multifunctional network switch determines its performance that is required. It should also be noted that the multifunctional high-speed network switch explained above by way of example may be adapted to perform industrial applications in the field of automation technology.

In addition, the storage device 32 stores at least one further program, namely a second program for executing a non-safety-related control device functionality and/or a third program for executing a router functionality and/or a fourth program for executing a safety-related control device functionality. It should be noted that in particular the second, third, and/or fourth programs may each be downloaded into the storage device 32 in the form of an application and can be installed in the multifunctional network switch 30. Each application runs in a virtual machine representing, for example, a virtual safety-related control device, a virtual non-safety-related control device, or a virtual router. The applications can be downloaded via an external computer which may exemplary be connected to port 40 or can be downloaded directly from an app store.

The control unit 31 is able to access the programs stored in storage device 32. It is adapted, for example based on an operating system which can also be stored in the storage device 32, to execute a network switch functionality by running the first program, and/or a non-safety-related control device functionality by running the second program, and/or a router functionality by running the third program, and/or a safety-related control device functionality by running the fourth program. In other words: if installed, the first, second, third, and fourth programs can be executed simultaneously or separately from each other in terms of time.

It should be mentioned that according to an advantageous implementation, the multifunctional network switch 30 stores an operating system which executes the network switch functionality, i.e. the first program, through which the further programs or applications and/or also the ports are provided.

What can be considered as a distinctive feature of the process-controlling automation system 10 is that in particular the multifunctional network switch 30 and in the present example the input and/or output modules 60 and 90 are able to communicate with one another via a common bus system, namely bus system 80 in the present case. Bus system 80 is preferably an SPE-based bus system, i.e. based on Single Pair Ethernet technology. In this case, the communication interface 34 is an SPE-based interface which can be electrically connected to a complementary SPE-based interface 81 of the bus system 80.

Similarly, the safety-related input and/or output module 60 has an SPE-based interface 62 that can be electrically connected to a further complementary SPE-based interface 82 of the bus system 80. Input and/or output module 60 may have a plurality of SPE-based interfaces 61₁-61ₙ to which SPE-based safety-related field devices 110, 101 can be directly connected. In this case, no gateways are required to perform communication protocol conversion.

Similarly, the non-safety-related input and/or output module 90 has an SPE-based interface 92 that can be electrically connected to a further complementary SPE-based interface 83 of the bus system 80. Input and/or output module 90 may have a plurality of SPE-based interfaces 91₁-91ₙ to which SPE-based non-safety-related field devices 110, 111 can be directly connected. Gateways that have to perform a communication protocol conversion will not be required in this case either.

According to an advantageous embodiment, power supply of multifunctional network switch 30 and optionally of the field devices that may be connected to the input and/or output modules 60 and 90 can be done via what is known as PoDL technology. Herein, the abbreviation PoDL stands for “Power over Data Line”. According to PoDL technology, the external power supply device 20 can transfer power via the SPE-based bus system 80 to the multifunctional network switch 30 and to the input and/or output modules 60 and 90.

For this purpose, the power supply device 20 has an SPE-based interface 21 which can be electrically connected to a further complementary SPE-based interface 84 of the bus system 80.

Power supply device 20 can preferably provide a direct voltage, for example a direct voltage of 24 V.

The process-controlling automation system 10 as shown in FIG. 1, by way of example, allows the power supply device 20 to be able to transmit not only power but also data, such as diagnostic data, for example, via the bus system 80 to the multifunctional network switch 30. If, for example, the multifunctional network switch 30 works as a virtual safety-related control device, i.e. control unit 31 executes the fourth program, the diagnostic data from power supply device 20 can be evaluated and processed by the multifunctional network switch 30, for example for safely controlling the safety-related field devices connected to the input and/or output module 60, as far as the control unit 31 executes the fourth program which relates to the control device functionality, for example.

The operation principle of multifunctional network switch 30 will now be explained by way of example.

Assuming that the power supply device 20 transfers diagnostic data, which for example indicate faulty operation of the power supply device 20, to control unit 31 via interfaces 21 and 84, via bus system 80, and via interfaces 81 and 34, and via high-speed bus 33. Control unit 31 is adapted to recognize that diagnostic data have been transmitted. In response to the diagnostic data received from power supply device 20, the control unit 31 executes the fourth program stored in storage device 32, i.e. the functionality of a safety-related virtual PLC. According to one possible scenario, it is contemplated that in response to the diagnostic data, the control unit 31 brings all safety-related actuators (not shown) connected to the input and/or output module 60 into a safe state by supplying corresponding control data from control unit 31 to the respective safety-related actuators, via high-speed bus 33 and interfaces 34 and 81, and via bus system 80 and interfaces 82 and 62.

According to a further exemplary scenario, it may be contemplated that the process-controlling automation system 10 as shown in FIG. 1 is to communicate with the Internet connected to port 50. In this case, control unit 31 executes the router functionality as stored in storage device 32 and causes the multifunctional network switch 30 to handle communication between the Internet and the process-controlling automation system 10 via port 50.

It is conceivable, for example, that the measurement data generated by a safety-related sensor connected to the input and/or output module 60, such as sensor 100, are to be stored on the Internet. To this end, the measurement data are transmitted from sensor 100 via bus system 80 to the multifunctional network switch 30 and then via port 50 to the Internet, under the control of control unit 31 which operates as a virtual router.

It is also conceivable for the control unit 31 of the multifunctional network switch 30 to simultaneously work as a virtual router and virtual safety-related control device, for example. The control unit 31 acting as a virtual safety-related control device is configured to evaluate the measurement data received from sensor 100 and to forward respective control data to a predetermined safety-related actuator connected to input and/or output module 60, e.g. actuator 101, for example in order to move the actuator 101 into a safe state.

At least some of the above aspects are again summarized below.

A multifunctional network switch 30 is provided for use in a process-controlling automation system 10, which multifunctional network switch 30 may comprise the following features:
a control unit 31 which may be in the form of a microcontroller,
a plurality of ports or interfaces 40-43 and 50-52, and
a storage device 32 which can store a first program for executing a network switch functionality and furthermore a second program for executing a control device functionality and/or a third program for executing a router functionality,
wherein the control unit 31 is configured to execute a network switch functionality by running the first program and to furthermore execute a control device functionality by running the second program and/or a router functionality by running the third program.

Advantageously, the control unit 31 is configured to assign at least some of the ports to the respective functionality to be executed depending on the respective program to be processed.

Expediently, the multifunctional network switch 30 may have an SPE-based interface 34 to which an external power supply device 20 can be connected for power supply of the multifunctional network switch based on PoDL technology.

Preferably, the multifunctional network switch 30 is in the form of a module adapted for being mounted on a mounting rail 70.

According to an advantageous embodiment, the multifunctional network switch 30 can be electrically connected to at least one input and/or output module 60, 90 via a bus system 80, for communication with field devices 100, 101, or 110, 111, respectively.

Storage device 32 may store a non-safety-related control device functionality as a second program and a safety-related control device functionality as a fourth program, wherein control unit 31 is adapted to execute a safety-related control device functionality by running the fourth program.

Multifunctional network switch 30 can preferably be a high-speed network switch, in particular a Gigabit Ethernet switch. At least some ports 40-43 of the plurality of ports 40-43 and 50-52 may be high-speed ports, each of which may be designed to transmit and receive data at a transfer rate of at least 100 Mbit/s, preferably 1 Gbit/s, 2.5 Gbit/s, 5 Gbit/s, 10 Gbit/s, 25 Gbit/s, 50 Gbit/s, 100 Gbit/s and more, wherein the control unit 31 can be adapted to execute a network switch functionality by running the first program and to switch data between the high-speed ports 40-43 at a data transfer rate of at least 100 Mbit/s, preferably 1 Gbit/s, 2.5 Gbit/s, 5 Gbit/s, 10 Gbit/s, 25 Gbit/s, 50 Gbit/s, 100 Gbit/s and more, in particular based on a routing table.

According to a further aspect, a process-controlling automation system 10 is provided, which has the following features:
a bus system 80,
a multifunctional network switch 30 as discussed above, which can be electrically connected to the bus system 80, and
at least one input and/or output module 60, 90 which can be electrically connected to the bus system 80.

Advantageously, the bus system 80 is an SPE-based bus system which is adapted for being arranged in a mounting rail 70.

The multifunctional network switch 30 is advantageously adapted to control the automation system 10 under execution of the second program by the control unit 31.

Advantageously, the automation system 10 may comprise an external power supply device 20 which has an SPE-based interface 21 and which can be connected to an SPE-based interface 34 of the multifunctional network switch 30, wherein the external power supply device 20 is adapted to use a PoDL technology for power supply of in particular the multifunctional network switch 30.

It should be noted that the programs which can be stored in storage device 32, for example in the form of an application, represent virtual machines such as, for example, a virtual router, a virtual safety-related control device, a virtual non-safety-related control device. In other words: in addition to its actual task as a network switch, the multifunctional network switch 30 performs at least the functions of a virtual machine.

1. A multifunctional network switch for use in a process-controlling automation system, comprising:
a control unit;
a plurality of ports; and
a storage device adapted to store a first program for executing a network switch functionality and furthermore a second program for executing a control device functionality and/or a third program for executing a router functionality;
wherein the control unit is adapted to execute a network switch functionality by running the first program and furthermore a control device functionality by running the second program and/or a router functionality by running the third program.

2. The multifunctional network switch of claim 1,
wherein the control unit is configured to assign at least some of the ports to a respective functionality to be executed depending on the respective program to be run.

3. The multifunctional network switch of claim 1,
comprising an SPE-based interface to which an external power supply device can be connected for power supply of the multifunctional network switch based on PoDL technology.

4. The multifunctional network switch of claim 1,
wherein the multifunctional network switch is in the form of a module adapted for being mounted on a mounting rail.

5. The multifunctional network switch of claim 4,
wherein the multifunctional network switch can be electrically connected to at least one input and/or output module via a bus system, for communication with field devices.

6. The multifunctional network switch of claim 1,
wherein the storage device is adapted to store a non-safety-related control device functionality as the second program and a safety-related control device functionality as a fourth program;
wherein the control unit is configured to execute a safety-related control device functionality by running the fourth program.

7. The multifunctional network switch of claim 1,
wherein the multifunctional network switch is in the form of a high-speed network switch comprising a Gigabit Ethernet switch;
wherein at least some of the plurality of ports are high-speed ports, each one adapted to transmit and receive data at a transfer rate of at least 100 Mbit/s; and
wherein the control unit is configured to execute a network switch functionality by running the first program and to switch data between the high-speed ports at a data transfer rate of at least 100 Mbit/s.

8. A process-controlling automation system comprising:
a bus system;
a multifunctional network switch according to claim 1, which can be electrically connected to the bus system; and
at least one input and/or output module that can be electrically connected to the bus system.

9. The process-controlling automation system of claim 8,
wherein the bus system is an SPE-based bus system which is adapted for being arranged in a mounting rail.

10. The process-controlling automation system of claim 8,
wherein the multifunctional network switch is configured to control the automation system under execution of the second program by the control unit.

11. The process-controlling automation system of claim 8, further comprising:
an external power supply device which has an SPE-based interface and which can be connected to an SPE-based interface of the multifunctional network switch, wherein the external power supply device is adapted to supply power to the multifunctional network switch using a PoDL technology.
